(19) United States
(12) Patent Application Publication
(10) Pub. No.: US 2026/0365487 A1
(43) Pub. Date: Nov. 19, 2026

(54) ELEVATOR, METHOD FOR INSTALLING ELEVATOR, BUILDING HAVING ELEVATOR, AND METHOD FOR CONSTRUCTING

(71) Applicant: HYUNDAI ELEVATOR CO., LTD, Chungcheongbuk-do (KR)

(72) Inventors: Tae Won Lee, Chungcheongbuk-do (KR); Sung Joon Bae, Chungcheongbuk-do (KR); Woo Sung Hwang, Chungcheongbuk-do (KR); Pyoung Yun Kim, Chungcheongbuk-do (KR); Dong Hwan Oh, Chungcheongbuk-do (KR); Jae Gu Choi, Chungcheongbuk-do (KR)

(21) Appl. No.: 19/434,656

(22) Filed: Dec. 29, 2025

(30) Foreign Application Priority Data
May 15, 2025 (KR) 10-2025-0063093

(51) Int. Cl. B66B 19/00; B66B 19/04; E04G 3/28; E04G 3/32

(52) U.S. Cl. CPC B66B 19/002; B66B 19/04; E04G 3/32; E04G 2003/286

(57) ABSTRACT

The method of constructing a building of the present disclosure proposes a technique for increasing the height of an operating elevator as the height of the building increases during building construction.

### CROSS-REFERENCE TO RELATED APPLICATIONS

This application is based on and claims priority under 35 U.S.C. § 119 to Korean Patent Application No. 10-2025-0063093 filed on May 15, 2025, with the Korean Intellectual Property Office, the disclosure of which is incorporated by reference herein in its entirety.

### BACKGROUND

The present disclosure relates to an elevator, a method for installing an elevator, a building having an elevator, and a method for constructing a building.

Technological advancements related to elevators are occurring rapidly. Elevators are advancing in step with the trend toward high-speed operation, high efficiency, eco-friendliness, and smarter operation. One example of this technological advancement is the modular elevator. Unlike conventional elevators, the modular elevators are machine-room-less (MRL) elevators, with their drive, control, and safety systems assembled as individual modules within the hoist way. The modular elevators are manufactured in advance by modularizing components at the elevator factory. They can then be easily assembled on-site. This shortens construction period and is effective in safety management and cost reduction. Other examples include preemptive fault detection and smart control technologies utilizing artificial intelligence (AI) and/or the Internet of Things (IoT). Furthermore, attempts are being made to expand the technology into future means of transportation, such as urban air mobility (UAM), which the applicant is researching. Thus, elevators are expanding beyond their mere means of transportation within buildings, and are undergoing various technological expansions.

An example of the technology for the modular elevator is Application No. 10-2024-199353, filed by the applicant herein, entitled “Entrance Module, Modular Elevator Including Entrance Module, and Method for Assembling Entrance Module.” This technology introduces a technology for precision assembly of the platform module. Another technology is Application No. 10-2024-0081110, filed by the applicant herein, entitled “Method for Manufacturing a Modular Elevator.” This technology introduces a technology for precision assembly of the rails.

Despite being installed within a building, the elevators are often treated as a separate process from the building itself. Consequently, numerous inconsistencies arise on-site.

### SUMMARY

The prior art has the following technical problems.

First, elevators can only be installed and operated after the framework structure is completed. Specifically, conventional elevator installation can occur after the framework, particularly the hoist way walls and machine room, have been fully constructed. Therefore, framework construction and elevator installation process cannot be performed concurrently, and the construction process must proceed sequentially, leading to a prolonged construction period.

Second, on-site elevator installation requires excessive manpower and time. Specifically, conventional methods involve transporting and assembling individual components (rails, doors, or the like) on-site. Consequently, complex tasks such as fixing, vertical alignment, and wiring within the framework are performed repeatedly in confined spaces. This results in variations in installation quality and compromises work safety.

Third, the inability of elevators to operate mid-level during high-rise construction significantly inefficiency in the movement of workers and materials. Specifically, conventional elevators can only operate after reaching the top floor. Consequently, during high-rise construction, logistics transport movement relies on cranes or external lifts. This reduces the efficiency of material transport and worker movement, and increases costs.

The method of constructing a building of the present disclosure proposes a technique for increasing the height of an operating elevator as the height of the building increases during construction.

According to the present disclosure, a method for constructing a building may include, when a first-height hoist way is provided during building construction, stacking and fastening at least two elevator modules in the first-height hoist way to install a first elevator; operating the first elevator; continuing the building construction so that the first-height hoist way is prepared as a second-height hoist way; separating a first module of the at least two elevator modules from the first elevator, thereby converting the first elevator into an intermediate body elevator; stacking and fastening at least one second module of the at least two elevator modules onto the intermediate body elevator, thereby installing a second elevator; and operating the second elevator.

The first module may be an upper end module disposed on upper ends of the first elevator and the second elevator.

The upper end module may be a machine room module in which a lifter is disposed.

The second elevator can operate to a higher elevation than the first elevator.

At least one of the at least two elevator modules may be introduced and withdrawn through an open opening at the uppermost end of the hoist way.

At least one of the at least two elevator modules may be hoisted and raised, and hoisted and lowered by a crane at a construction site.

The first module may be fastened using a first fastening method, the second module may be fastened using a second fastening method different from the first fastening method, and the first fastening method may be configured to be easier to separate than the second fastening method.

The second module may be an intermediate module installed corresponding to a platform.

At least one of the at least two elevator modules may be provided as a hexahedral frame in which bars of predetermined cross-sections extending in the vertical direction, in the front and rear direction, and in the left and right direction are fastened to each other.

At least one elevator component may be fixed to the frame.

The separated first module may be connected to the upper end of the second elevator so as to enable operation of the second elevator.

According to the present disclosure, a method for installing an elevator may include assembling and preparing at least two elevator modules, each providing an elevator, at an elevator production site; transporting the at least two elevator modules, fastening the at least two elevator modules in a first-height hoist way prepared at the construction site, thereby providing a first elevator; operating the first elevator; disassembling the operable first elevator; additionally transporting some of the at least two elevator modules, stacking and fastening some of the at least two elevator modules in a second-height hoist way prepared at the construction site, thereby providing a second elevator; and

operating the second elevator.

The first elevator may use a temporary traction machine and the second elevator may use a traction machine.

The method for installing an elevator may further include disassembling the second elevator; and

further transporting some of the modules of the at least two elevators, stacking and fastening some of the modules of the at least two elevators in a third-height hoist way prepared at the construction site, providing a third elevator and thereby operating the third elevator.

The method for installing an elevator may further include fastening the same upper end module to the upper ends of the first elevator and the second elevator.

The method for installing an elevator may further include additionally performing construction on a building having the first-height hoist way to provide the second-height hoist way.

The modules of the at least two elevators may include a lower end module provided at the lower ends of the first elevator and the second elevator; an upper end module provided at the upper ends of the first elevator and the second elevator; at least one intermediate module provided between the upper end module and the lower end module; and an adapter module for adjusting a gap between the lower end module, the upper end module, and the intermediate module.

Disassembling of the first elevator module may include when, during building construction, the height of at least one of the building and the hoist way is constructed to be higher than the upper end module by a predetermined height. Disassembling of the first elevator module may include when, during the building construction, the height of at least one of the building and the hoist way is expected to be higher than the upper end module by a predetermined height. For example, if space is secured for the upper end module to be located in the next construction stage, the first elevator module can be disassembled.

The upper end module may have a ceiling. The ceiling of the upper end module may be provided as an inclined ceiling having at least two inclined surfaces.

At least one of the following may be satisfied: at least two elevator modules are provided with a chain hook for lifting, at least two elevator modules are provided with a walk plate for workers to stand on, and at least two elevator modules are provided with a safety railing to prevent workers from falling.

The elevator may further include at least one sliding mechanism provided on an edge of at least one module among the at least two elevator modules to allow sliding between the modules of the at least two elevators and the inner surface of the hoist way.

The present disclosure may have the following effects:
First, elevators can be early put into operation before the building's framework is completed. For example, modules (frames) installed up to a certain floor can be linked to temporary traction machines and control systems. This allows for early operation of elevators regardless of the building's completion. Furthermore, this allows for partial installation and early operation of elevators during the intermediate stages of framework construction.
Second, it can greatly improve the efficiency of logistics transport and worker movement during construction before completion of high-rise structures.
Third, by carrying out the construction process and elevator installation in parallel, the construction period can be shortened, structural safety and construction precision can be secured, and construction costs can be reduced.
Fourth, the effects can be achieved by expanding to various applications such as building remodeling and logistics response in high-rise buildings.

### BRIEF DESCRIPTION OF THE DRAWINGS

FIGS. 1(a) and 1(b) are structural diagrams illustrating a building and an elevator, where FIG. 1(a) illustrates an elevator provided in a building, and FIG. 1(b) illustrates an elevator in which elevator modules are stacked.

FIGS. 2(a) and 2(b) are time tables illustrating a method for constructing a building of the present disclosure compared to the prior art, where FIG. 2(a) is the prior art and FIG. 2(b) illustrates a method for constructing a building of the present disclosure.

FIG. 3 is a drawing explaining the opening and the operation of the opening.

FIG. 4 is a drawing illustrating the disassembling of an elevator module.

FIGS. 5(a)-5(b) are drawings illustrating the reinstallation of the elevator module.

FIGS. 6(a)-6(b) are drawings explaining a structure in which an upper end module is supported on a hoist way according to an example 2, where FIG. 6(a) is a perspective view, FIG. 6(b) is a side view of a horizontal bar of the upper end module, and FIG. 6(c) is a cross-sectional view of a horizontal bar of the upper end module.

FIG. 7 is a perspective view illustrating the upper structure of the elevator including the upper end module.

FIG. 8 is a perspective view illustrating the upper end module further including the ceiling part.

FIG. 9 is a perspective view illustrating an upper end module according to example 3.

FIG. 10 is a perspective view illustrating a module according to example 4.

FIG. 11 is a flowchart illustrating a method of constructing a building according to example 5.

### DETAILED DESCRIPTION OF THE EMBODIMENTS

Hereinafter, specific embodiments of the present disclosure will be described in detail with reference to the drawings. The idea of the present disclosure is not limited to the following embodiments. Those skilled in the art who understand the idea of the present disclosure can easily propose other embodiments within the same idea by adding, modifying, deleting, or adding elements. However, this also falls within the idea scope of the present disclosure.

The present disclosure may include a plurality of embodiments. A first element of a first embodiment among the plurality of embodiments may be included by adding or modifying elements of another embodiment. A first element of a first embodiment among the plurality of embodiments and a second element of a second embodiment among the plurality of embodiments may be combined to provide another embodiment not specified in the plurality of embodiments.

In the description of the drawings, regardless of the drawing number and symbol, identical or similar elements are given identical or similar reference numbers, and redundant descriptions thereof may be omitted.

The drawings are provided solely to facilitate understanding of embodiments of the present disclosure, and the technical ideas of the present disclosure are not limited by the attached drawings. It should be understood that all modifications, equivalents, or alternatives included within the idea and technical scope of the present disclosure are included.

In describing the embodiments of the present disclosure, a detailed description of a related known technology may be omitted if it is determined that the detailed description may obscure the gist of the embodiments disclosed in the present specification.

In describing embodiments of the present disclosure, specific examples of related known technologies may be included in the specification. In this case, the technical connection between the known technologies and the present disclosure may be included within the technical idea of the present disclosure.

In the present disclosure, terms including ordinal numbers, such as “first,” “second,” or the like, may be used to describe various elements, but the elements are not limited by the terms. The terms may be used to distinguish one element from other element.

When an element is referred to as being “connected” or “accessed” to another element, it should be understood that it may be directly connected or accessed to other element, but that there may be other elements in between. Conversely, when an element is referred to as being “directly connected” or “directly accessed” to another element, it should be understood that there are no other elements in between.

A singular expression may include a plural expression unless the context clearly indicates otherwise.

In the present disclosure, terms such as “comprises” or “has” are intended to indicate the presence of a feature, number, step, operation, element, component, or combination thereof described in the specification. Therefore, they do not exclude the possibility of the presence or addition of one or more other features, numbers, steps, operations, elements, components, or combinations thereof.

In the present disclosure, if the direction is indicated, a direction of gravity can be defined as a vertical direction. A direction perpendicular to the direction of gravity can be defined as a left and right direction. A direction perpendicular to both the vertical and left and right directions can be defined as the front and rear direction. The front and rear direction can be exemplified by the direction viewed by an observer.

In the present disclosure, the “upper end module” refers to a module disposed at the uppermost portion of an elevator, and the upper end module may include a “machine room module” that supports a traction machine T according to an embodiment. Here, the term “machine room module” refers to a portion of the upper end module that performs the traction machine support function, and the two may be corresponding concepts. In the present disclosure, the “traction machine T” refers to a raising and lowering driving device for the official operation of the elevator, and the “winch T1” may refer to a temporary traction device used in the installation stage. The “crane 100” refers to an external lifting equipment (crane) at a construction site, and may be functionally distinguished from a traction machine or a winch.

In the present disclosure, the term “intermediate body elevator” may refer to a structure in which a lower end module and one or more intermediate modules are fastened while the upper end module is separated. The term “intermediate body elevator” may refer to a state where the operating function as an elevator can be restored by adding an upper end module and a traction device. In the present disclosure, the term “intermediate module” may refer to a module disposed between the upper end module and the lower end module.

### Example 1

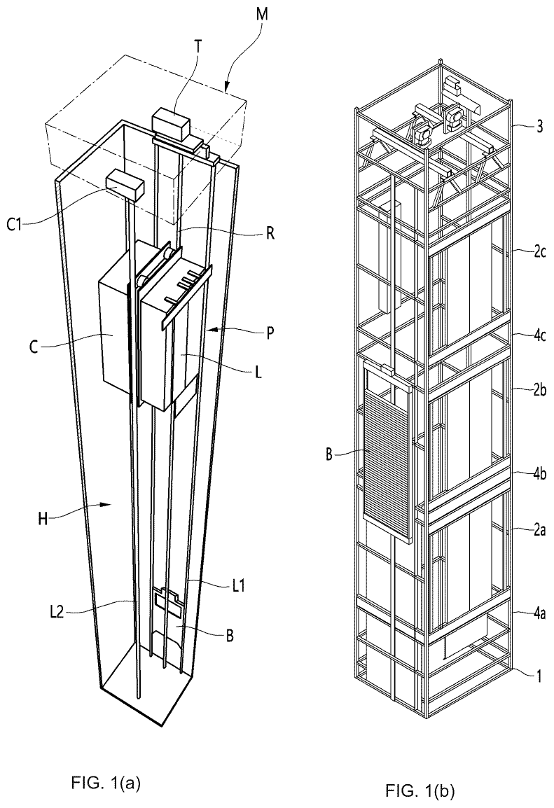

FIGS. 1(a) and 1(b) are structural diagrams illustrating a building and an elevator, where FIG. 1(a) illustrates an elevator provided in a building, and FIG. 1(b) illustrates an elevator in which elevator modules are stacked. See FIGS. 1(a) and 1(b).

### Configuration and Operation of Elevator

An elevator can be installed in a building. Here, the building can be exemplified by a reinforced concrete structure, a steel structure, and a modular structure. The building can provide a platform and a hoist way to install the elevator. The platform and the hoist way can form a component of the elevator. The platform P can be exemplified by an entrance/exit space of each floor where the car C stops. A plurality of platforms can be provided in the building. The hoist way H can be exemplified by a passage through which the car C is raised and lowered. Components such as a traction machine T and a control module C1 that raise and lower the car C can be disposed on the upper end of the hoist way.

A door module L may be provided on the platform. The door module can be opened and closed in conjunction with the door of the car C. The traction machine T can rotate the rope R in both directions. The rope R can be wound around a sheave provided on the output side of the traction machine T. The rope R can extend in both directions with the traction machine as the geometric center. In other words, the rope R is supported by the sheave, and both ends thereof can extend downward by gravity.

The car C may be supported on the first side where the rope extends in one direction. A counterweight B (balance weight) may be supported on the second side where the rope extends in the other direction. The counterweight may compensate for the weight of the car C and the load loaded on the car. The counterweight may reduce energy consumption of the elevator, smoothen the operation of the elevator, and increase the stability of the system. Various methods for connecting the rope R, the car C, and the counterweight B may be provided according to the specifications, use, allowable load, and standards of the building and the elevator. Various methods for connecting the rope R, the car C, and the counterweight B may be included in the idea of the present disclosure.

According to the control of the control module C1, the traction machine T can be selectively driven. By moving the rope R wound around the sheave, the car C can move in the hoist way H in the vertical direction. By moving the rope R wound around the sheave, the car C and the counterweight B can move in the vertical direction. At this time, the car C and the counterweight B can move in opposite directions to each other. The vertical movement of the car C and the counterweight B can be guided by the first rail L1 and the second rail L2.

According to the control of the control module C1, the car C can stop at a specific location. The car C can stop corresponding to a specific platform P. The door of the car C and the door module L of the specific platform can be opened together.

Additional portions may be required for the configuration and operation of the elevator. For example, the counterweight B may also be provided with a sheave around which the rope R is wound. Even if each portion is not described in the present disclosure, the applicant declares that the portions necessary for the configuration and operation of the elevator are included in the present disclosure.

### Configuration and Operation of Rails L1 and L2

The rails L1 and L2 can be installed to extend vertically from the inner surface of the hoist way H. The rails L and L2 can be fastened to the inner surface of the hoist way H. The rails L and L2 can be directly fastened to the inner surface of the hoist way H using a single type of fastener or indirectly fastened using two or more types of fasteners. The rails Land L2 can guide the vertical movement of the car C and the counterweight B. The rails can prevent the car C and the counterweight B from swinging in the left and right direction and in the front and rear direction. The rails can have a plurality of sub-components connected vertically. The sub-components can refer to sub-components that form a component of the elevator. For example, a rail part of a predetermined length that provides a component as a single rail that is a component of the elevator can be referred to as a sub-component with respect to the single rail. The same applies hereinafter.

If the alignment of the sub-components is misaligned, problems such as vibration may occur during elevator operation. Furthermore, once the rail is fixed, it is difficult to adjust the alignment of the rail even if an error in the alignment of the rail is confirmed due to the amplified joint tolerance between a plurality of sub-components. As a technology to resolve this, the applicant's prior art application No. 10-2024-0081110, entitled “Method for Manufacturing a Modular Elevator,” discloses a fish plate, a clip member, and a fixing block for aligning. Precisely fixing the rail to the reference position can be said to be one of the core technologies in the field of elevator technology.

### Elevator Module

The modules of the elevator can be classified according to the height at which the modules are stacked in the hoist way. For example, the modules can include a lower end module 1 at the lowest floor. An intermediate module 2 can be stacked on top of the lower end module corresponding to each platform. The door module L can be installed corresponding to the intermediate module. At least two 2a, 2b, and 2c of the intermediate modules can be provided. An adapter module 4 that directly contacts the intermediate module can be provided on at least one of the upper end and the lower end of one of the intermediate modules. The adapter module 4 can be provided to adjust the vertical spacing between each module according to the specifications of the building. At least two 4a, 4b, and 4c of the adapter modules 4 can be provided as needed. An upper end module 3 can be stacked on the upper side of the highest intermediate module among the at least two intermediate modules.

The module may be provided by fastening bars having predetermined cross-sections extending in the vertical direction, in the front and rear direction, and in the left and right direction. The module may be provided as a hexahedral frame in which a plurality of the bars are connected. The cross-section of the bar may have at least one bent part. The cross-section of the bar may be provided as a square. The cross-section of the bar may be provided as a hollow square. The cross-section of the bar may be provided as a hollow square with one edge removed. The cross-section of the bar may be provided as a hollow square with two consecutive edges removed. The module consisting of the bars may be fastened to the building or another adjacent module. Components of the elevator may be fixed and assembled to the frame. For example, rails, doors, buffers, or the like may be pre-assembled to the frame at the elevator production site.

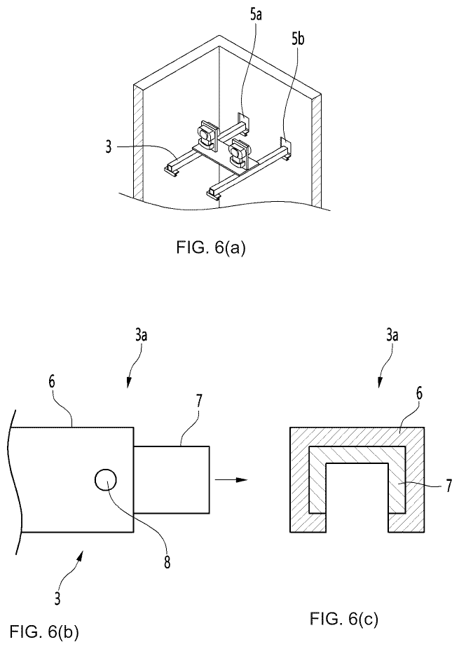

Any one of the intermediate modules may be provided corresponding to any one of the platforms. In other words, one door module L may correspond to one intermediate module that is stacked. Of course, according to the specifications of the modules, one or more door modules may correspond to one intermediate module, or one or more intermediate modules may correspond to one door module. This may correspond to various specifications of the building. A pit module may be provided in the lower end module 1. The pit module may be disposed at the lowest end portion of the elevator, and a buffer and a sensor may be installed therein. The pit module may be directly disposed on the foundation structure during the construction of the building. A machine room module may be provided in the upper end module 3. The machine room module may provide a space for supporting a driving device. The traction machine T, the winch T1, electrical wiring, and control equipment may be supported therein. The upper end module 3 may be provided in two layers. A winch and a work plate may be provided on the lower layer of the two layers. A ceiling (see 10 in FIGS. 6(a)-6(c)) may be provided on an upper end of the upper layer of the two layers.

As a module of the elevator, a shaft module may be provided. The shaft module may provide a guide for a car to safely raise and lower by contacting the shaft module. The shaft module may include the rail and electrical wiring. At least one of the shaft module and the door module may be pre-fastened to the intermediate module. Here, the meaning of “pre-fastened” may mean that the module is fastened to the frame providing the module and moves together during movement.

As a module of the elevator, the control module C1 may be provided. In a narrow sense, the control module may refer to a control panel disposed in the machine room. In a broad sense, the control module C1 may include components such as a control panel, a communication device, an emergency backup power source, a remote monitoring system, a power line, a control line, and a safety circuit. The control module may also be disposed in other areas of the building other than the hoist way and the platform.

### Installation of Elevator Modules

The elevator modules can be installed during the construction of a building, or concurrently with the construction of the building. For example, the building construction may include foundation work to solidify the ground, framework construction to build the frame of a building, and finishing construction which finishes the interior and exterior of the framework. In the present disclosure, each module of the elevator can be stacked concurrently with the framework construction. The stacked elevator modules can provide an operable elevator.

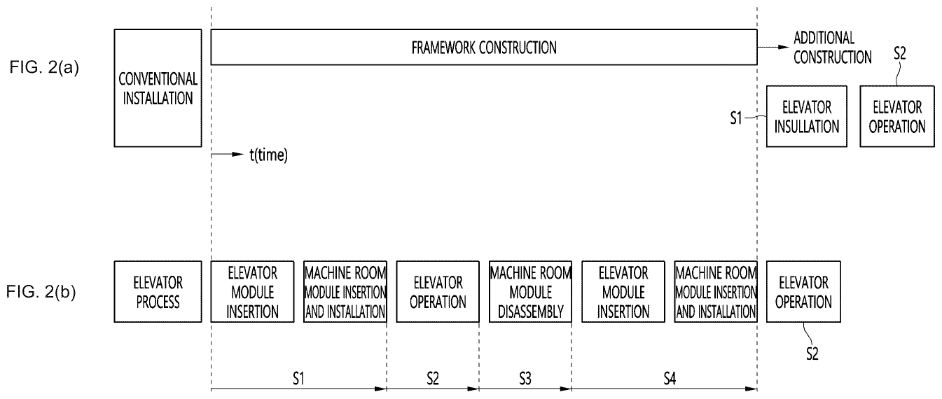

FIGS. 2(a) and 2(b) are time tables illustrating a method for constructing a building of the present disclosure compared to the prior art, where FIG. 2(a) is the prior art and FIG. 2(b) illustrates a method for constructing a building of the present disclosure. See FIGS. 2(a) and 2(b).

Building construction can be performed in a time series manner (progressing in the direction of t). According to the prior art, after the framework construction is completed, an elevator installation (S1) can be performed as a process of the additional construction. The elevator installation (S1) can take a long time. Therefore, it can take a long time until the elevator operation (S2). Due to the delay in the elevator operation (S2), the additional construction can be delayed and the construction cost can increase. For example, since it is inconvenient to move to each platform P at different heights, the additional construction takes more time and cost.

According to the present disclosure, the installation (S1) of the elevator can be performed together with the framework construction. During the framework construction, the hoist way can be provided in an open state. The open state of the hoist way can include an open upper end of the hoist way. The hoist way can be blocked in the front and rear direction and left and right direction. Of course, the platform and the hoist way can be connected to each other. The hoist way can be located inside a building. The hoist way can extend in the vertical direction while having a blocked lower end. The hoist way can extend vertically. The uppermost end of the hoist way can be open to an external space to provide an opening. Components of the elevator and modules of the elevator can be introduced through the opening. The opening can be closed with a temporary cover. For example, the temporary cover can be normally closed and opened when components are introduced into the hoist way.

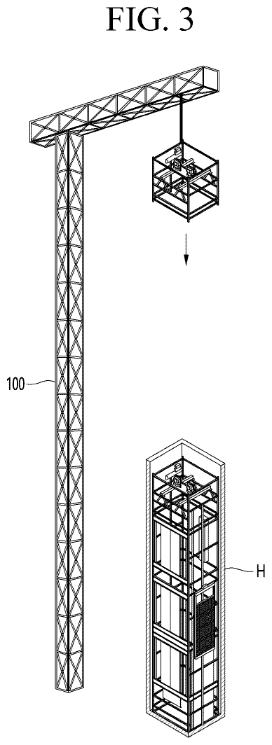

FIG. 3 illustrates the opening and the operation of the opening. See to FIG. 3. A crane 100 capable of lifting an elevator module having a predetermined weight is prepared. The crane can lift the elevator module 1, 2, and 3 and introduce the elevator module into the hoist way. Specifically, the operation of the crane can perform an operation of hoisting and raising the elevator module, an operation of vertically aligning the elevator module with the opening of the hoist way, an operation of lifting and lowering the elevator module inside the hoist way, and an operation of fixing and removing the elevator module from the hoist way.

See to FIGS. 2 and 3 together. The elevator installation (S1) will be described in detail. The modules 1, 2, 3, and 4 of the elevator can be installed sequentially. The drawing illustrates that the process proceeds in time series: first, installation of an elevator module (for example, an intermediate module 2); second, introduction and installation of a machine room module (for example, an upper end module 3); third, installation of a winch; fourth, installation of a car C; and fifth, removal of a winch.

First, the installation of the module of the elevator may include the lower end module 1. If the lower end module is performed integrally with the framework construction, the installation may begin with the intermediate module. For example, the pit module may be integrated with the framework during the framework construction. The first step may be repeatedly performed according to the height of the framework construction. Second, the introduction and installation of the machine room module may include the introduction and installation of the upper end module of the elevator. At this time, a traction machine and a winch may be provided together in the machine room. Third, the installation of the winch may include installing a rope to the winch. The winch may perform the lifting of the car required for the installation of the elevator component. The winch may be distinct from the traction machine and may be a lifter which is temporarily used. Fourth, the installation of the car C may include providing and installing a plurality of components that provide the elevator. The installation of the car may include winding a rope around the traction machine. Fifth, the removal of the winch may include removing a winch that has been retired from use. After this, elevator operation (S2) may be possible.

In the hoist way, the frames of each module of the elevator can be sequentially stacked from the lower portion. To ensure alignment and fixation between the frames during the stacking process, the frames can be provided with an interconnection structure or fixing part between the frames. As another example, the frames can be fastened to the surface of the hoist way. One frame can be fastened to at least one of the inner surface of the hoist way and another adjacent frame.

### Disassembly of Elevator Module

Building construction can continue while the elevator is in operation. As building construction progresses, the hoist way height may also increase. If the elevator's operating height is lower than the building's intended height, the elevator's usability will be compromised. Consequently, the installation of a new elevator may be necessary.

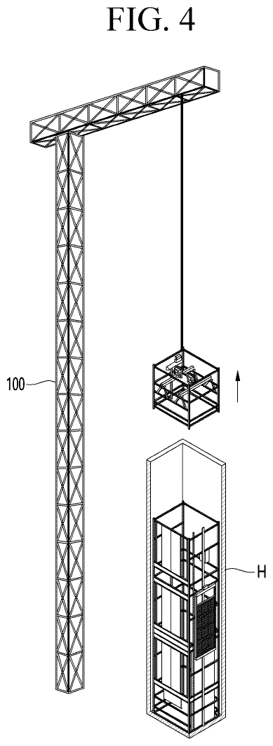

FIG. 4 is a drawing illustrating the disassembling of an elevator module. See FIGS. 2(a) and 2(b) to FIG. 4.

The elevator module installed by the [Installation of Elevator Module] can be disassembled during building construction (S3). At this time, the elevator module to be disassembled may include the upper end module 3. The upper end module may be fastened to components of a surrounding elevator by a first fastening method. The first fastening method may be a method that allows separation for disassembling. As previously described, the upper end module may include a machine room module. The intermediate module may not be disassembled. The intermediate module may remain inside the constructed building. The intermediate module may be fastened to components of a surrounding elevator by a second fastening method. The second fastening method may be a method that is non-separable or firmly fastened. The first fastening method may have lower strength and sturdiness than the second fastening method, but may have the advantage of being easy to separate. For example, the first fastening method may include bolt fastening, and the second fastening method may use methods such as welding, nuts, and rivets. The lower end module, like the intermediate module, may not be disassembled.

The elevator from which the upper end module is separated may be referred to as an intermediate body elevator. The intermediate body elevator may be a state of being fastened to the lower end module and at least one intermediate module. The intermediate body elevator cannot function as an elevator. Since the intermediate body elevator is a state of being fastened to a plurality of elevator modules, it can function as an elevator by fastening a few additional elevator modules. The intermediate module may be additionally stacked on the intermediate body of the elevator. The intermediate body of the elevator may be capable of operating as an elevator by fastening the upper end module and connecting components.

The disassembled elevator module can be performed when, during the building construction, at least one of the building and the hoist way is constructed to be higher by a predetermined height than the upper end module, or when, during the building construction, at least one of the building and the hoist way is expected to be higher by a predetermined height than the upper end module and is disassembled first.

### Reinstallation of Elevator Module

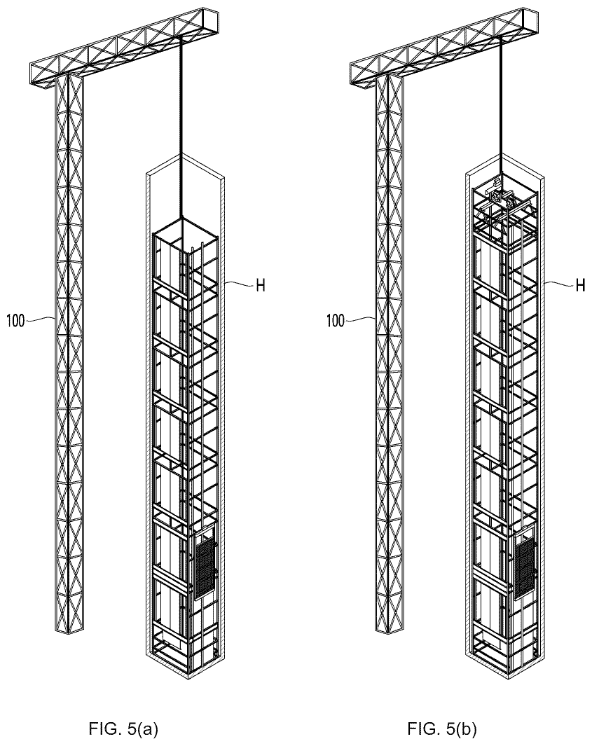

With the upper end module disassembled as described above [Disassembly of Elevator Module], the intermediate module 2 can be further stacked. FIGS. 5(a)-5(b) are drawings illustrating the reinstallation of the elevator module. See FIGS. 2(a) and 2(b) to FIGS. 5(a) and 5(b).

The number of stacked intermediate modules may vary depending on the height of the constructed building or the number of platforms. After the intermediate modules are stacked, the upper end module may be stacked (S4). The upper end module may be a previously disassembled upper end module. The stacked elevator modules may provide an operable elevator. For other processes required for elevator installation, refer to [Elevator Installation] above described.

In this way, the present disclosure can satisfy the following conditions: that the elevator operates at a first height and at a second height, depending on the building construction, wherein the second height is higher than the first height. Accordingly, the process of installing/disassembling/reinstalling the elevator can be performed corresponding to a building or a hoist way whose height increases depending on the building construction. The process of installing/disassembling/reinstalling the elevator can be repeated as many times as necessary.

### Application of Example to Presence or Absence of Machine Room

The present example exemplifies an elevator of the machineless type without a machine room M. However, the idea of the present disclosure is not inapplicable to a building having a machine room. For example, the machine room M may be provided at the upper end of the hoist way. Components such as a traction machine T and a control module C1 for raising and lowering the car C may be disposed in the machine room M. The machine room M may be provided with a predetermined movable wall. The wall may separate the hoist way and the machine room. When the machine room is provided, a frame for a portion of the upper end module may be provided to the machine room. When the machine room is provided, the upper end module 3 may not be provided separately. The machine room M may be provided as a step in the building construction after the intermediate module is provided. Thereafter, the traction machine T and the control module C1 may be installed inside the machine room. However, the idea of the present disclosure may be more suitable for the machineless type elevator.

### Example 2

The example 2 discloses the configuration of the upper end module. The present example discloses the configuration of an elevator module corresponding to the elevator module being introduced through an opening on the upper surface of a building. Portions similar to those of the first example will be omitted, and other portions will be described with emphasis.

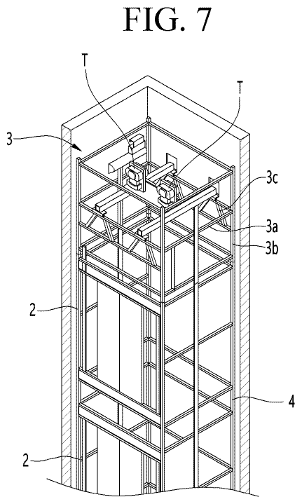

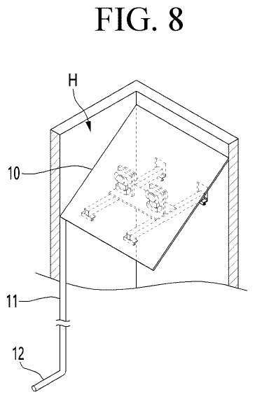

FIGS. 6(a)-6(b) are drawings explaining a structure in which an upper end module is supported on a hoist way according to an example 2, where FIG. 6(a) is a perspective view, FIG. 6(b) is a side view of a horizontal bar of the upper end module, and FIG. 6(c) is a cross-sectional view of a horizontal bar of the upper end module. FIG. 7 is a perspective view illustrating the upper structure of an elevator including an upper end module. FIG. 8 is a perspective view illustrating the upper end module further including the ceiling part.

The intermediate module 2 and the adapter module 4 (optional) can be stacked in the vertical direction. The upper end module 3 can be provided at the upper end of the hoist way. The upper end module 3 can include a vertical bar 3b extending in the vertical direction and a horizontal bar 3a extending in the front and rear direction and in the left and right direction. In order to increase the strength of the bars 3a and 3b, a reinforcing bar 3c extending in an inclined direction can be provided. The reinforcing bar can be provided to be inclined obliquely with respect to any one of the vertical direction/front and rear direction/left and right direction. Here, the inclination angle can be less than 90 degrees and greater than 0 degrees. The inclination angle can be in the range of 40-50 degrees. The reinforcing bar 3c can have at least two reinforcing parts, one end of which can be in contact with each other, and the other end can be spaced apart from each other. Here, the contact can include direct contact or indirect contact. Here, one end of the at least two reinforcing parts can support the same bar together. Here, the other ends of the at least two reinforcing parts can support different bars.

A traction machine T can be disposed on the bars 3a, 3b, 3c. A winch T1 can be disposed on the bars 3a, 3b, 3c. The traction machine and the winch can be disposed on the horizontal bar 3a. The horizontal bar 3a on which the traction machine or the winch is disposed can have higher strength than other bars. The horizontal bar on which the traction machine and the winch are disposed can be supported by the reinforcing bar.

The horizontal bar 3a may be provided as an elastic bar. The horizontal bar 3a may be provided in a structure in which two bars overlap in the longitudinal direction. Referring mainly to FIG. 4(b). The horizontal bar 3a is provided in a configuration in which at least two bars 6 and 7 overlap in the longitudinal direction. One of the bars included in the horizontal bar may be withdrawn or introduced in from the other. The bars of the horizontal bar may freely move relative to each other in the longitudinal direction (for example, the front and rear direction). In contrast, the bars of the horizontal bar may not move relative to each other in the width direction (for example, the left and right direction) or the bending direction (for example, the virtical direction). The horizontal bar 3a may reach a predetermined length by withdrawing at least two bars 6, 7.

The both end portions of the horizontal bar may be fixed to opposite surfaces of the hoist way. The horizontal bar may be inserted into the hoist way in a shortened state in length. Thereafter, after the horizontal bar has been extended in length, both ends of the horizontal bar may be fixed to opposite surfaces of the hoist way. Here, the fixing may include insertion or fitting.

Both end portions of the horizontal bar can be inserted into holes 5a and 5b on the inner surface of the hoist way H. Here, the holes may be in the form of pocket holes or concave recesses. In the drawing, one end portion of two different horizontal bars can be inserted into two holes 5a, 5b. When the horizontal bar 3a is fixed to the holes 5a and 5b, the lengths of the two bars 6, 7 providing the horizontal bar can be fixed. In order to fix the lengths of the two bars, a connecting hole 8 connecting the two bars 6, 7 can be provided. A fastening member such as a bolt can be inserted into the connecting hole 8. The fastening member can fasten the two bars together. The fastening member can prevent the length of the horizontal bar from changing.

Disassembling the upper end module can be performed by reversing the installation process of the horizontal bar.

When the upper end module 3 is fastened to the hoist way, the upper portion of the hoist way remains open until the building is finished. In other words, the opening remains open until the building is finished. Rainwater and foreign substances may fall through the opening. To prevent this, a ceiling 10 may be installed on the upper portion of the upper end module. For example, the ceiling 10 may prevent damage to workers and elevator components due to fallen objects during construction, and deterioration of elevator components due to rainwater and foreign substances. A discharge part 11 for guiding (inducing) the fallen object may be provided on one side of the ceiling. When the fallen object is rainwater, the discharge part may be a drain pipe. A discharge hole 12 for guiding the fallen object to the platform may be provided at the lower end of the discharge part. The discharge hole may be closed during the finishing construction.

The ceiling 10 and the structure 11, 12 for withdrawing fallen objects from the ceiling may also be provided for the intermediate module. For example, after one of the intermediate modules is installed, a predetermined period of time may elapse during the building construction step. In this case, damage due to foreign substances, similar to the upper end module, may occur to the intermediate module. Accordingly, the ceiling may also be installed for the intermediate module. If another module is stacked above the intermediate module, the ceiling may be removed. The ceiling 10 and the structure 11, 12 for withdrawing fallen objects from the ceiling may also be provided for the lower end module 1.

The ceiling 10 and the structure 11, 12 for withdrawing fallen objects from the ceiling can be removed after the elevator installation is completed. The completion of the elevator installation may include blocking the opening on the upper surface of the building, that is, the upper end opening of the hoist way.

### Example 3

The present example discloses the configuration of the upper end module. The present example discloses the configuration of the upper end module corresponding to the opening of the upper surface of the hoist way. Portions similar to those of example 1 and example 2 are omitted, and different portions are mainly described.

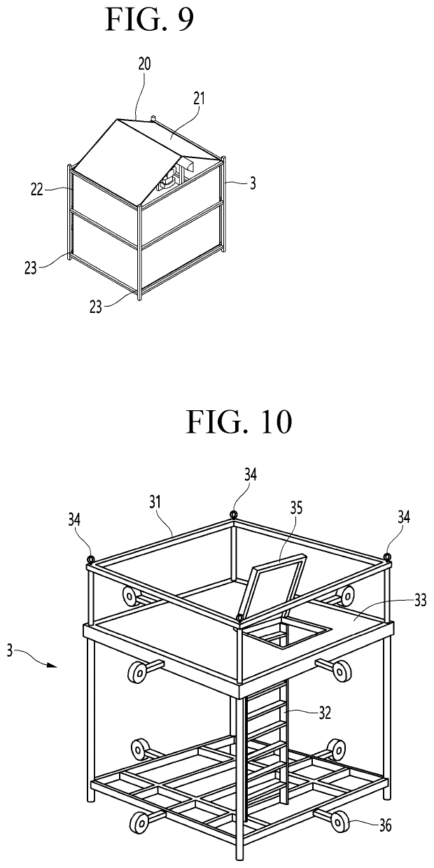

FIG. 9 is a perspective view illustrating an upper end module according to example 3. See to FIG. 9.

The upper end module 3 may be provided with a ceiling that is a sloped ceiling 20. The sloped ceiling 20 may be provided to be inclined in at least two directions (two directions in the drawing). The sloped ceiling 20 may be provided to be inclined downwards as it goes toward the corner. The sloped ceiling may provide at least two sloped surfaces. The corner 21 of the sloped surfaces may provide a boundary of at least two sloped surfaces. A drain pipe 22 and a drain hole 23 may be provided on each sloped surface. The drained water may be guided to the platform. The drained water may not affect elevator components disposed in the hoist way.

The sloped ceiling 20 can handle large amounts of rainfall flowing into the open upper surface of the hoist way. For example, in cases of high rainfall, such as during the rainy season, typhoons, and tropical rainy seasons, the ceiling of the example 2 cannot handle such situations. In such cases, the sloped ceiling can quickly discharge the rainfall to multiple locations.

### Example 4

The present example discloses the configuration of the modules of the elevator. The modules may include a lower end module, an intermediate module, an upper end module, and an adapter module. The present example discloses a module configuration that accommodates frequent installation and disassembly operations. Portions similar to those of the first through third examples will be omitted, and other portions will be described with emphasis.

FIG. 10 is a perspective view illustrating a module according to example 4. See to FIG. 10.

When installing or disassembling the modules 1, 2, 3, 4, a worker must have access. Among the modules, the upper end module may be exemplified. However, this can also be applied to other modules. A configuration that ensures worker accessibility and safety may be included. These configurations may be provided on the frame.

The modules 1, 2, 3, 4 may be provided with a chain hanger 34. The chain hanger may be provided so that the crane 100 can perform hoisting and raising work. The worker can disconnect the crane 100 and the chain hanger 34 after the module is introduced to an appropriate position in the hoist way. A walk plate 33 may be provided so that the worker can work on the upper surface of the module. The chain hanger and the walk plate may also be used for disassembling the module. A ladder 32 may be provided so that the worker can climb up to the walk plate. An access door 35 may be provided so that the worker can climb up to the upper portion of the module using the ladder 32. A height-adjustable safety railing 31 may be provided between the hoist way and the work space to prevent the worker from falling while working.

The modules 1, 2, 3, 4 may be provided with a sliding mechanism 36. The module may be introduced and removed into the inner surface of the hoist way. Even if the crane is precisely adjusted, the module may come into contact with the hoist way. This may lead to damage to the module and the hoist way. If the module is an upper end module, the damage may occur frequently during the hoisting and raising of the upper end module, as it cannot be observed by the operator of the crane. The sliding mechanism 36 may be provided at an edge portion of the module. The sliding mechanism may include a roller and an extension mechanism extending the roller outward. The roller may be provided at a corner or vertex of the frame (hexahedron). The example is illustrated as having eight rollers provided at each corner. However, the present invention is not limited thereto, and four rollers may be provided, one for each vertical bar. The sliding mechanism 36 may be provided in accordance with the relationship between the hoist way and the frame.

### Example 5

The present example details a method for constructing a building. The method also includes a method for installing an elevator as a portion of the building.

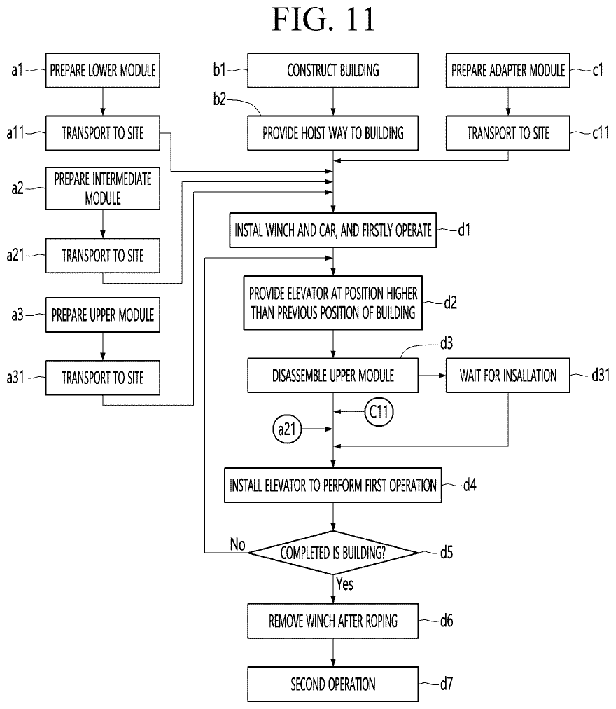

FIG. 11 is a flowchart illustrating a method of constructing a building according to example 5. See to FIG. 11.

Building construction and elevator module production can be performed at different sites. Here, the elevator module may include at least one of a lower end module, an intermediate module, and an upper end module. The lower end module, intermediate module, and upper end module may each have a frame (a hexahedron provided with a plurality of bars) prepared independently. The frame may have components, including at least one of a rail, a door, a toe guard, and a buffer, fastened to it. The fastening of the components may be provided at the elevator manufacturing site. The frame may be the minimum unit for on-site transport and installation of the elevator. The frame may be provided for each platform. By performing the process, at least one of lower end module preparation (a1), intermediate module preparation (a2), and upper end module preparation (a3) may be performed. Optionally, adapter module preparation (c1) may be performed. The adapter module preparation (c1) may be performed only when necessary. The present disclosure may include manufacturing of any one module at any one elevator manufacturing site. In other words, manufacturing may also include manufacturing at different elevator manufacturing sites, as needed.

The modules prepared through the lower end module preparation (a1), intermediate module preparation (a2), upper end module preparation (a3), and adapter module preparation (c1) can be transported to the site (a11), (a21), (a31), (c11) when necessary. The transportation of each of the modules (including the frame) to the construction site can be carried out in parallel with the framework construction. For example, the corresponding module can be pre-shipped to the construction site when the framework construction in which it is to be installed is being performed. Accordingly, the required module can be reflected in a timely manner. Accordingly, the construction site can be uncomplicated. Each module of the elevator manufacturing site can be managed with a low inventory rate. Accordingly, the production management of elevator components can be facilitated.

Separately from the module preparation, building construction may be performed (b1). During the building construction, a hoist way may be provided in a portion of the building (b2).

The lower end module 1 may be installed in the hoist way. The adapter module 4 may then be optionally installed. The installation of the lower end module in the hoist way may be performed through an upper opening of the building, as previously described. Thereafter, at least one intermediate module 2 and the upper end module 3 may be installed. Thereafter, a winch T1 and a car C may be operably installed in the upper end module (d1). The winch may be a temporary traction machine used for temporary hoisting and raising. Through the process, the installation of the elevator (see S1 of FIG. 2(b)) is completed, and the elevator can be operated (see S2 of FIG. 2(b)).

Due to building construction, the building may have a hoist way located higher than the previous portion (d2). At this time, the upper end module can be disassembled (d3). The disassembled upper end module can then be awaited for reinstallation (d31).

Thereafter, the adapter module and the intermediate module may be stacked. The stacking of the adapter module and the intermediate module may correspond to the current height of the building and the current number of platforms. For example, if there are four platforms above the upper end module, including the upper end module, before the upper end module is disassembled, three or four intermediate modules may be stacked. When three intermediate modules are stacked, the disassembled upper end module may be disposed on one platform. This may be when the building is continuously stacked. In this case, the upper end module disassembling process (d3) may be performed again later. When four intermediate modules are stacked, the space for the disassembled upper end module to be disposed above one platform may be additionally provided. This may be when the building's framework construction is completed. In this case, the upper end module dismantling process (d3) may not be performed again later.

Afterwards, the upper end module can be reinstalled, and the winch T1 and the car C can be reinstalled to the upper end module so that they can be operated (d4). Through the process, the installation of the elevator (see S4 of FIG. 2(b)) is completed, and the elevator operation (see S2 of FIG. 2(b)) can be resumed. The dismantling to reinstallation of the upper end module (d2 to d4) can be performed until the completion of the building (d5). Here, the completion of the building construction can include the completion of the framework construction.

When the building construction is completed (d5), the traction machine T can be roped and the winch T1 can be removed (d6). Thereafter, the elevator can be operated normally (S2). The operation by the traction machine T can be referred to as the second operation, and the operation by the winch (temporary traction machine) can be referred to as the first operation. The first operation can be an operation with low-speed constraints. In contrast, the second operation can be an operation that allows smooth operation at high speeds.

### INDUSTRIAL APPLICABILITY

The present disclosure may provide various advantages to elevators and buildings having such elevators.

What is claimed is:

1. A method for constructing a building, comprising:
when a first-height hoist way is provided during building construction, stacking and fastening at least two elevator modules in the first-height hoist way to install a first elevator;
operating the first elevator;
continuing the building construction so that the first-height hoist way is prepared as a second-height hoist way;
separating a first module of the at least two elevator modules from the first elevator, thereby converting the first elevator into an intermediate body elevator;
stacking and fastening at least one second module of the at least two elevator modules onto the intermediate body elevator, thereby installing a second elevator; and
operating the second elevator.

2. The method for constructing a building of claim 1, wherein the first module is an upper end module disposed on upper ends of the first elevator and the second elevator.

3. The method for constructing a building of claim 1, wherein the upper end module is a machine room module in which a lifter is disposed.

4. The method for constructing a building of claim 1, wherein the second elevator can operate to a higher elevation than the first elevator.

5. The method for constructing a building of claim 1, Wherein at least one of the at least two elevator modules is introduced and withdrawn through an open opening at the uppermost end of the hoist way.

6. The method for constructing a building of claim 5, wherein at least one of the at least two elevator modules is hoisted and raised, and hoisted and lowered by a crane at a construction site.

7. The method for constructing a building of claim 1,
wherein the first module is fastened using a first fastening method,
wherein the second module is fastened using a second fastening method different from the first fastening method, and
wherein the first fastening method is configured to be easier to separate than the second fastening method.

8. The method for constructing a building of claim 1, wherein the second module is an intermediate module installed corresponding to a platform.

9. The method for constructing a building of claim 1,
wherein at least one of the at least two elevator modules is provided as a hexahedral frame in which bars of predetermined cross-sections extending in the vertical direction, in the front and rear direction, and in the left and right direction are fastened to each other, and
wherein at least one elevator component is fixed to the frame.

10. The method for constructing a building of claim 1, wherein the separated first module is connected to the upper end of the second elevator so as to enable operation of the second elevator.

11. A method for installing an elevator comprising:
assembling and preparing at least two elevator modules, each providing an elevator, at an elevator production site;
transporting the at least two elevator modules, stacking and fastening the at least two elevator modules in a first-height hoist way prepared at the construction site, thereby providing a first elevator;
operating the first elevator;
disassembling the operable first elevator;
additionally transporting some of the at least two elevator modules, stacking and fastening some of the at least two elevator modules in a second-height hoist way prepared at the construction site, thereby providing a second elevator; and
operating the second elevator.

12. The method for installing an elevator of claim 11,
wherein the first elevator uses a temporary traction machine and
wherein the second elevator uses a traction machine.

13. The method for installing an elevator of claim 11, further comprising:
disassembling the second elevator; and
further transporting some of the modules of the at least two elevators, stacking and fastening some of the modules of the at least two elevators in a third-height hoist way prepared at the construction site, providing a third elevator and thereby operating the third elevator.

14. The method for installing an elevator of claim 11,
wherein at least one of the following is satisfied:
the same upper end module is fastened to the upper ends of the first elevator and the second elevator;
construction is additionally performed on a building having the first-height hoist way to provide the second-height hoist way; and
the modules of the at least two elevators include: a lower end module provided at the lower ends of the first elevator and the second elevator; an upper end module provided at the upper ends of the first elevator and the second elevator; at least one intermediate module provided between the upper end module and the lower end module; and an adapter module for adjusting a gap between the lower end module, the upper end module, and the intermediate module.

15. The method for installing an elevator of claim 11,
wherein disassembling of the first elevator module is performed when, during building construction, the height of at least one of the buildings and the hoist way is constructed to be higher than the upper end module by a predetermined height, and when, during the building construction, the height of at least one of the buildings and the hoist way is expected to be higher than the upper end module by a predetermined height.

16. A building provided by the method of claim 1.

17. An elevator provided by the method of claim 11.

18. The elevator of claim 17, wherein the ceiling of the upper end module is provided as an inclined ceiling having at least two inclined surfaces.

19. The elevator of claim 17,
wherein at least one of the following is satisfied:
at least two elevator modules are provided with a chain hook for lifting, at least two elevator modules are provided with a walk plate for workers to stand on, and at least two elevator modules are provided with a safety railing to prevent workers from falling.

20. The elevator of claim 17, further comprising:
at least one sliding mechanism provided on an edge of at least one module among the at least two elevator modules to allow sliding between the modules of the at least two elevators and the inner surface of the hoist way.
